(19) United States
(12) Patent Application Publication
(10) Pub. No.: US 2024/0338380 A1
(43) Pub. Date: Oct. 10, 2024

(54) DATA TRANSFORM OPERATIONS IN A DATA TRANSFORM ACCELERATOR

(71) Applicant: MAXLINEAR, INC., Carlsbad, CA (US)

(72) Inventors: Pinaki Shankar Chanda, San Diego, CA (US); Michael Ray Ham, San Jose, CA (US)

(73) Assignee: MAXLINEAR, INC., Carlsbad, CA (US)

(21) Appl. No.: 18/596,556

(22) Filed: Mar. 5, 2024

Related U.S. Application Data
(60) Provisional application No. 63/494,004, filed on Apr. 4, 2023.

(51) Int. Cl. G06F 16/25; G06F 21/60

(52) U.S. Cl. CPC G06F 16/258; G06F 21/602

(57) ABSTRACT

A method includes obtaining, by a data transform accelerator, first metadata. The method also includes configuring a first pipeline in the data transform accelerator using the first metadata. The method further includes obtaining input data to be transformed by the data transform accelerator. The method also includes generating encoded data and second metadata in the first pipeline using the input data and the first metadata. The encoded data and the second metadata may be stored together for later operations, such as decode operations. The method further includes configuring a second pipeline in the data transform accelerator using the second metadata.

### CROSS REFERENCE TO RELATED APPLICATIONS

This U.S. Patent Application claims priority to U.S. Provisional Patent Application No. 63/494,004, titled “REDUCE LATENCY AND IMPROVE THROUGHPUT FOR DATA TRANSFORM ALGORITHM ACCELERATION IN DECODE DIRECTION,” and filed on Apr. 4, 2023, the disclosure of which is hereby incorporated by reference in its entirety.

### TECHNICAL FIELD

This disclosure generally relates to data transform acceleration, and more specifically, to improving data transform operations in a data transform accelerator particularly in a decode direction by using metadata generated in an encode process.

### BACKGROUND

Unless otherwise indicated herein, the materials described herein are not prior art to the claims in the present application and are not admitted to be prior art by inclusion in this section.

Data transform accelerators are co-processor devices that are used to accelerate data transform operations for various applications such as data analytics applications, big data applications, storage applications, cryptographic applications, and networking applications. For example, a data transform accelerator can be configured as a storage accelerator and/or a cryptographic accelerator.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining first metadata from a user or another device, such as a host processor, using a data transform accelerator. The method may also include configuring a first pipeline in the data transform accelerator using the first metadata. The method may further include obtaining input data to be transformed by the data transform accelerator. The method may also include generating encoded data and second metadata using the input data and first metadata in the first pipeline. The second metadata may be stored with the encoded data for later operations, such as decoding the encoded data. The method may further include configuring a second pipeline in the data transform accelerator using the second metadata. The configuration of the second pipeline may be used for efficient decoding of the encoded data.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example environment for improving data transform operations in a data transform accelerator;

FIG. 2 illustrates a block diagram of an example environment for improving data transform operations in a data transform accelerator;

FIG. 3 illustrates a flowchart of an example method of improving data transform operations in a data transform accelerator; and

FIG. 4 illustrates an example computing device.

### DETAILED DESCRIPTION

A data transform accelerator may be used as a coprocessor device in conjunction with a host device to accelerate data transform operations for various applications, such as data analytics, big data, storage, and/or networking applications. The data transform operations may include, but not be limited to, compression, decompression, encryption, decryption, authentication tag generation, authentication, data deduplication, non-volatile memory express (NVMe) protection information (PI) generation, NVMe PI verification, and/or real-time verification.

Data transform operations performed by the data transform accelerator may be separated based on a direction associated with the data, such as an encode direction (associated with transmitting and/or encoding data) and a decode direction (associated with receiving and/or decoding encoded data). For example, encode direction data transform operations may include NVMe PI verification on input data, compression, deduplication hash generation, padding, encryption, cryptographic hash generation, and NVMe PI generation on encoded data, real-time verification on the encoded data, and/or a combination of one or more of the preceding encode direction data transform operations. In another example, decode direction data transform operations may include NVMe PI verification on the encoded data, deduplication hash generation on input data and/or transformed data (e.g., obtained from the input data), decryption, depadding, cryptographic hash verification generated on the input data and/or the transformed data, decompression, NVMe PI verification on decoded data, and/or a combination of one or more of the preceding decode direction data transform operations.

The data transform accelerator may include various data transform engines that may be configured in a pipeline to perform the various data transform operations, in either the encode direction or the decode direction. For example, a first pipeline may include a first arrangement of the data transform engines and may be operable to perform the encode direction data transform operations. In another example, a second pipeline may include a second arrangement of the data transform engines and may be operable to perform the decode direction data transform operations.

In some circumstances, data transform operations performed in the encode direction (e.g., by data transform engines included in a first pipeline) may generate metadata and/or other outputs that may be utilized by a second pipeline and/or associated data transform engines configured to perform data transform operations in the decode direction. For example, according to some aspects of the present disclosure, at least some output(s) from the encode direction data transform operations may generate metadata that may be used in a decode direction pipeline that may facilitate data transform operations performed in the decode direction pipeline. In such instances, the data transform operations performed in the decode direction (e.g., data transform operations performed by the data transform engines in a pipeline in the decode direction) may reduce latency of data transform operations in the decode direction and/or may increase throughput of the data transform operations in the decode direction.

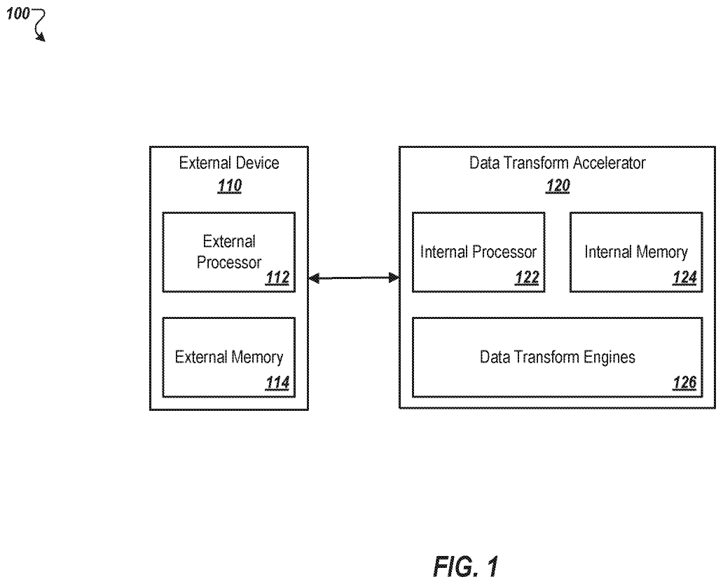

FIG. 1 illustrates a block diagram of an example environment 100 for improving data transform operations in a data transform accelerator 120, in accordance with at least one embodiment of the present disclosure. The environment 100 may include an external device 110 and the data transform accelerator 120. The external device 110 may include an external processor 112 and an external memory 114. The data transform accelerator 120 may include an internal processor 122, an internal memory 124, and data transform engines 126.

In some embodiments, the external device 110 (e.g., a host computer, a host server, etc.) may be in communication with the data transform accelerator 120 via a data communication interface (e.g., a Peripheral Component Interconnect express (PCIe) interface, a Universal Serial Bus (USB) interface, and/or other similar data communication interfaces). In some embodiments, upon a request by a user to transform source data that may be located in the external memory 114, software (e.g., a software driver) on the external device 110 and operated by the external processor 112 may be directed to generate metadata (such as, but not limited to, data transform command pre-data including a command description, a list of descriptors dereferencing a different section of the metadata, and a list of descriptors dereferencing source data and destination data buffers, command pre-data including transform algorithms and associated parameters, source and action tokens describing different sections of the source data and transform operations to be applied to different sections, and/or additional command metadata) with respect to transforming the source data in the external memory 114. In some embodiments, the software may generate the metadata in the external memory 114 based on the source data that may be obtained from one or more sources. For example, the source data may be obtained from a storage associated with the external device 110 (e.g., a storage device), a buffer associated with the external device 110, a data stream from another device, etc. In these and other embodiments, obtaining the source data may include copying or moving the source data to the external memory 114.

In some embodiments, the software may direct the external processor 112 to generate the metadata associated with the source data. In some embodiments, the metadata may be stored in one or more input buffers. For example, in instances in which the metadata includes a data transform command that may contain a list of source descriptors, destination descriptors, command pre-data, source and action tokens, and additional command metadata, each of the individual components of the metadata may be stored in individual input buffers (e.g., the data transform command in a first input buffer, pre-data in the second input buffer, the source and action tokens in the third input buffer, and so forth). In some embodiments, the input buffers associated with the metadata may be located in the external memory 114. Alternatively, or additionally, the input buffers associated with the metadata may be located in the internal memory 124. Alternatively, or additionally, the input buffers may be located in both the external memory 114 and the internal memory 124. For example, one or more input buffers associated with the metadata may be located in the external memory 114 and one or more input buffers associated with the metadata may be located in the internal memory 124. In these and other embodiments, the external processor 112 may direct the software to reserve one or more output buffers that may be used to store an output from the data transform accelerator 120. In some embodiments, the output buffers may be located in the external memory 114. In some embodiments, the output buffers may be located in the internal memory 124 of the data transform accelerator 120.

In instances in which the software directs the external processor 112 to generate the metadata and store the metadata in the internal memory 124 (e.g., in the input buffers located in the internal memory 124), the external processor 112 may transmit commands to the data transform accelerator 120 (e.g., such as to a component of the data transform accelerator 120, such as the internal processor 122) via the data communication interface. For example, the internal memory 124 may be accessible and/or addressable by the external processor 112 via the data communication interface, and, in instances in which the data communication interface is PCIe, the internal memory 124 may be mapped to an address space of the external device 110 using a base address register associated with an endpoint of the PCIe (e.g., the data transform accelerator 120).

In some embodiments, the software may direct the data transform accelerator 120 to process a data transform command. For example, the software may direct the data transform accelerator 120 to obtain an address that may point to the data transform command. In some embodiments, the data transform command may be used by the data transform accelerator 120 to transform the source data based on data transform operations included in the data transform command. In some embodiments, the data transform operations that may be performed as directed by the data transform command may be performed by the data transform engines 126. In some embodiments, the data transform engines 126 may be arranged according to the data transform command and/or the metadata (e.g., the metadata stored in the external memory 114 and/or stored in the internal memory 124), such that the data transform engines 126 form a data transform pipeline that may be configured to perform the data transform operations to the source data.

In some embodiments, the address and/or the data transform command may be located in the external memory 114. In such instances, the data transform accelerator 120 (e.g., the internal processor 122) may obtain the address and/or may access the data transform command in the external memory 114 using the data communication interface. Alternatively, or additionally, the address and/or the data transform command may be located in the internal memory 124, and the address may be obtained by the internal processor 122 and/or the data transform engines 126.

In these and other embodiments, external device 110 may use the data communication interface to transmit metadata to the data transform accelerator 120, which the internal processor 122 may direct to be stored in the internal memory 124 and the internal processor 122 may return the address of the stored metadata to the external processor 112. Alternatively, or additionally, the external device 110 may use the data communication interface to transmit metadata directly to the internal memory 124 of the data transform accelerator 120.

In some embodiments, data transform operations performed by the data transform engines 126 (e.g., one or more data transform operations performed in the data transform pipeline, as described herein) may produce second metadata that may be used to configure a second pipeline in the data transform accelerator 120, as described herein.

The data transform accelerator 120 may be operable to perform data transform operations using one or more pipelines, the pipelines including a configuration of the data transform engines 126. The pipelines in the data transform accelerator 120 may be described as performing data transform operations in at least two directions, an encode direction and/or a decode direction. The encode direction data transform operations performed by a first pipeline in the data transform accelerator 120 may include one or more of NVMe PI verification on input data, compression, deduplication hash generation, padding, encryption, cryptographic hash generation, and NVMe PI generation on encoded data, and/or real-time verification on the encoded data. The decode direction data transform operations performed by a second pipeline in the data transform accelerator 120 may include one or more of NVMe PI verification on the encoded data, deduplication hash generation on input data and/or transformed data (e.g., obtained from the input data), decryption, depadding, decompression, NVMe PI verification on the decoded data, and/or cryptographic hash verification generated on the input data and/or the transformed data.

In some embodiments, the data transform accelerator 120 may be configured to support multiple data transform sessions, where a data transform session may include source data, associated metadata, and the data transform engines 126 (e.g., arranged in a data transform pipeline), as described herein. In some embodiments, one or more data transform commands may include the same or similar algorithms in the data transform operations. In such instances, the individual data transform commands may be grouped together into a data transform session. In some embodiments, the multiple data transform commands grouped into a data transform session may include the same or similar metadata. In such instances, the data transform accelerator 120 may store the source data and/or the metadata in the internal memory 124, as described herein, and the data transform accelerator 120 may provide the address to external device 110, such that the external device 110 may include the addresses within the data transform commands belonging to the session.

In these and other embodiments, one or more source descriptors may be included in the multiple data transform commands that may point to one or more input buffers that may be configured to store the metadata shared across multiple commands in a session. Alternatively, or additionally, the multiple data transform commands may include one or more source descriptors that may point one or more input buffers that may be configured to store the source data and/or the metadata that may be unique to different commands of the session. In instances in which a first data transform command and a second data transform command have the same input data and/or metadata, the corresponding source descriptors may point to the same input buffer(s). In instances in which the first data transform command and the second data transform command have different input data and/or metadata, the corresponding source descriptors may point to different input buffers, as applicable.

For example, a first data transform session may include a first data transform command that may include first source data in a first input buffer and associated first metadata stored in a second input buffer of the internal memory 124, and one or more data transform engines 126 may be arranged in a first data transform pipeline. The first data transform session may include a second data transform command that may include the first source data (stored in the first input buffer) and the first metadata. Alternatively, or additionally, the second data transform command may utilize the shared source data and/or shared metadata to perform the data transform operations. In the examples, the first data transform command and the second data transform command may include the same source descriptors as the first data transform command and the second data transform command may use the same source data and/or metadata stored in respective input buffers.

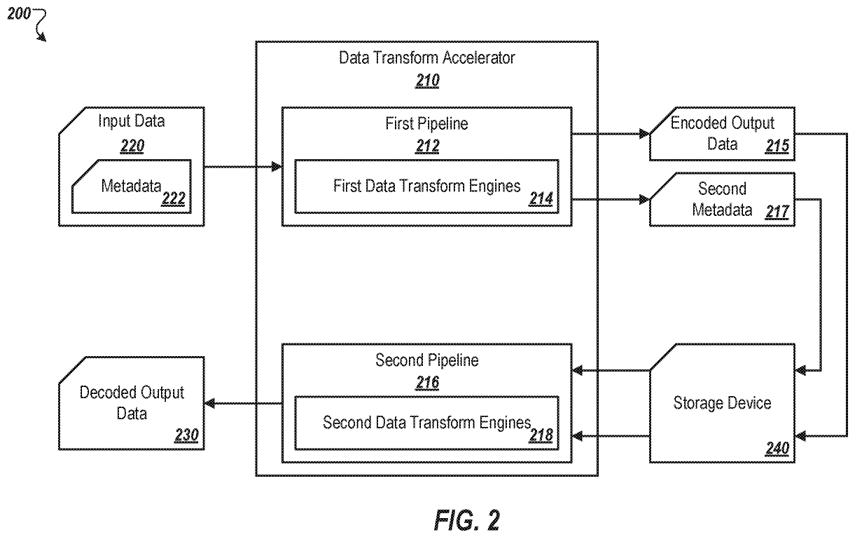

The data transform accelerator 120 and/or the components included therein may be implemented using various systems and/or devices. For example, the data transform accelerator 120 may be implemented in hardware, software, firmware, a field-programmable gate array (FPGA), a graphics processing unit (GPU), and/or a combination of any of the above listed implementations. An example of the implementation and/or operations of a first pipeline and/or a second pipeline in a data transform accelerator may be further illustrated and described relative to FIG. 2 herein.

Modifications, additions, or omissions may be made to the environment 100 without departing from the scope of the present disclosure. For example, the designations of different elements in the manner described is meant to help explain concepts described herein and is not limiting. Further, the environment 100 may include any number of other elements or may be implemented within other systems or contexts than those described. For example, any of the components of FIG. 1 may be divided into additional or combined into fewer components.

FIG. 2 illustrates a block diagram of an example environment 200 for improving

data transform operations in a data transform accelerator, in accordance with at least one embodiment of the present disclosure. The environment 200 may include a data transform accelerator 210. The data transform accelerator 210 may include a first pipeline 212 and a second pipeline 216. The first pipeline 212 may include first data transform engines 214 and the second pipeline 216 may include second data transform engines 218.

The data transform accelerator 210 may be the same or similar as the data transform accelerator 120 of FIG. 1. Alternatively, or additionally, the first data transform engines 214 and/or the second data transform engines 218 may be the same or similar as the data transform engines 126 of FIG. 1. As such, the data transform accelerator 210, the first data transform engines 214, and/or the second data transform engines 218 may be operable to perform the same or similar operations as described relative to the similarly named components described in FIG. 1, unless otherwise described.

In some embodiments, the first pipeline 212 may be operable to perform encode direction data transform operations, as described herein, and the second pipeline 216 may be operable to perform decode direction data transform operations, as described herein.

In some embodiments, an external device may provide the instructions to the first pipeline 212 directing second metadata 217 to be generated. For example, the external device 110 of FIG. 1 may provide instructions to the first pipeline 212 (e.g., via the data transform accelerator 210) directing the first pipeline 212 (and/or the first data transform engines 214) to generate the second metadata 217 during the encode direction data transform operations.

Alternatively, or additionally, the first pipeline 212 may obtain instructions

associated with metadata (e.g., the second metadata 217) to generate the second metadata 217, where the second metadata 217 may be used by the second pipeline 216. For example, the data transform accelerator 210 may provide the instructions (e.g., such as by an internal processor associated with the data transform accelerator 210) to the first pipeline 212 (and/or the first data transform engines 214 included in the first pipeline 212) directing the second metadata 217 to be generated that may be used by the second pipeline 216, as described herein.

The data transform accelerator 210 may obtain input data 220, which may include data to be transformed (e.g., by the data transform accelerator 210 and/or the components of the data transform accelerator 210) and/or metadata 222 that may be used to configure the first data transform engines 214 into the first pipeline 212 and/or the second data transform engines 218 into the second pipeline 216. For example, the metadata 222 may be used to determine one or more data transform operations to be performed by the first data transform engines 214 and/or the second data transform engines 218, such that the first data transform engines 214 and the second data transform engines 218 may be configured into the first pipeline 212 and the second pipeline 216, respectively. In some embodiments, the metadata 222 may include a flag or other indicator that may be used as an instruction to the data transform accelerator 210 to generate the second metadata 217.

In some instances, the metadata 222 that may be used to configure the first pipeline 212 may be the same or similar as the second metadata 217 that may be used to configure the second pipeline 216, where the direction of operation may differ (e.g., an encode direction for the first pipeline 212 and a decode direction for the second pipeline 216). In such instances, the first pipeline 212 may be operable to output the second metadata 217 that is similar to the metadata 222 where the flag indicating the direction of operations may be updated in the second metadata 217 to be in the decode direction. Further, in instances in which NVMe PI is generated, the first pipeline 212 may add padding, as described herein, to the second metadata 217.

Alternatively, or additionally, the software (e.g., which may be running on the data transform accelerator 210 and/or an external device, as described herein) may be operable to copy the metadata 222 associated with data transform operations in the encode direction and use the copied metadata as the second metadata 217 associated with data transform operations in the decode direction (which may include the software directing the flag indicating the direction of operations being updated from the encode direction to the decode direction).

In some embodiments, the metadata 222 may be utilized by the data transform accelerator 210 to configure the first pipeline 212 using the first data transform engines 214. The first pipeline 212 may obtain the input data 220 and perform data transform operations to the input data 220, such as using the first data transform engines 214, and the first pipeline 212 may generate encoded output data 215 and/or second metadata 217. The second metadata 217 and/or the metadata 222 may be utilized by the data transform accelerator 210 to configure the second pipeline 216 using the second data transform engines 218.

In these and other embodiments, the second metadata 217 may include some or all of a data transform command for decode direction data transform operations, to be used by the second pipeline 216. For example, the second metadata 217 may include references to source descriptors and/or destination descriptors that may be utilized to configure the second data transform engines 218 into the second pipeline 216, such as to perform the decode direction data transform operations and generate decoded output data 230.

In some embodiments, the data transform command metadata for decode direction data transform operations may be compressed and/or encrypted, such as during data transform operations performed by the first pipeline 212. In such instances, the second pipeline 216 and/or one or more particular data transform engines (e.g., a decompression data transform engine and/or a decryption data transform engine) may be operable to perform a first decompression and/or first decryption to the data transform command for decode direction data transform operations in advance of the second pipeline 216 performing data transform operations on the encoded output data 215 to generate the decoded output data 230.

The first pipeline 212 may be operable to obtain the input data 220 and generate the encoded output data 215 and/or the second metadata 217, as described herein. In some instances, the first pipeline 212 (e.g., encode direction data transform operations by the first data transform engines 214) may generate NVMe PI in association with the encoded output data 215. In such instances, the data transform command for the decode direction data transform operations (e.g., in the second metadata 217) may be padded relative to an NVMe PI sector size. The NVMe PI may be T10-DIF and/or T10-DIX. In instances in which the NVMe PI is T10-DIF, the protection information may be inserted in the decode direction data transform operations. In instances in which the NVMe PI is T10-DIX, the protection information may be returned as sideband data, such as, in a separate output buffer(s) in an external memory or in an internal memory of the data transform accelerator 210. The T10-DIX information may be stored separately from encoded/transformed data from the data transform accelerator 210 whereas the T10-DIF may be stored along with the encoded/transformed data. In these and other embodiments, the data transform command for the decode direction data transform operations may be sized such that one NVMe PI sector size (e.g., 512 bytes) may store the data transform command for the decode direction data transform operations.

In instances in which encode direction data transform operations generate NVMe PI, command structure elements, as described herein, may be generated by the first data transform engines 214 and/or included in the second metadata 217. In such instances, the command structure elements may be padded to fill an NVMe PI sector size and/or protection information (e.g., APP, REF, and/or GUARD fields of the NVMe PI) may be added. Alternatively, or additionally, the APP field may be set to an appropriate value different from the APP fields of the protection information added to the NVMe PI sectors containing the encoded output data 215.

In instances in which an encryption key is included in the second metadata 217 (e.g., as generated by at least one of the first data transform engines 214) and subsequently erased, some NVMe PI (e.g., T10-DIF) may be computed with regard to the encryption key prior to being removed from the second metadata 217. Alternatively, or additionally, in instances in which the encryption key is replaced with a placeholder, the NVMe PI may be computed with regard to a zero-filled placeholder in lieu of the encryption key. As such, the data transform accelerator 210 may be operable to determine whether an encryption key may be covered by NVMe PI, or a zero-filled placeholder when performing a validation of the NVMe PI (e.g., by at least one of the second data transform engines 218) in the command structure elements for the decode direction data transform operations.

In these and other embodiments, the first pipeline 212 may be operable to perform NVMe PI generation that may be separated from the encoded output data 215 (e.g., and may be included in the second metadata 217). Alternatively, or additionally, the first pipeline 212 may be operable to concatenate command structure elements with the encoded output data 215 and the perform NVMe PI generation once a particular amount of padding has been added (e.g., depending on whether T10-DIF or T10-DIX is implemented).

In some instances, a storage device 240 may be associated with the data transform accelerator 210 and may be operable to store the encoded output data 215 and/or the second metadata 217 until a later time when the second pipeline 216 may be established and may perform the decode direction data transform operations. The storage device 240 may be remote from the data transform accelerator 210 (e.g., the external memory 114 of

FIG. 1). Alternatively, or additionally, the storage device 240 may be included in the data transform accelerator 210, such as in the internal memory 124 of FIG. 1, and may be operable to store the encoded output data 215 and/or the second metadata 217 until a later time when the data transform accelerator 210 may be ready to configure the second pipeline 216. For example, the encoded output data 215 and/or the second metadata 217 may be stored in the storage device 240 until a user determines to perform decode operations. Upon receiving the user input, the software (e.g., such as described relative to FIG. 1, which may be on an external device and/or the data transform accelerator 210) may generate the data transform command for the decode direction data transform operations using the second metadata 217, which may reduce a number of CPU cycles and/or time associated with preparing the data transform command for the decode direction data transform operations.

In some instances, the second metadata 217 may include one or more command structure elements associated with the data transform command for the decode direction data transform operations. The command structure elements may include session control words, source tokens, action tokens, additional metadata, and/or offsets associated with the command structure elements.

The session control words may describe one or more algorithms that may be applied by the second pipeline 216 (e.g., the decode direction), first and/or last command in a stateful operation, direction of operation (e.g., the decode direction), etc. The source tokens may describe a delineation of metadata in the data transform command for the decode direction data transform operations. The action tokens may described a delineation of the input encoded output data 215 where the algorithms may be applied. For example, the action tokens may delineate a first portion of the encoded output data 215 undergo no data transform operations, a second portion of the encoded output data 215 undergo decryption and decompression data transform operations, and so forth. The additional metadata may include authentication data, key length, and/or compression algorithm parameters (e.g., static Huffman codebook). The offsets may provide a layout of the other command structure elements within the second metadata 217. For example, the offsets may notify a processing element, such as in the second pipeline 216, which portion of the second metadata 217 is session control words, which is source tokens, and so forth.

In some embodiments, a layout of the data transform command for the decode direction data transform operations (e.g., the source descriptors and/or associated source buffers, the destination descriptors and/or associated destination buffers, and/or data and/or metadata to be included therein) may be configured by a post-processing device, such as the external processor 112 and/or the external device 110 of FIG. 1. The layout may be configured using the some or all of the second metadata 217, such as the offsets

In instances in which a user indicates the encoded output data 215 from the first pipeline 212 is to be input into the second pipeline 216, the software (which may be associated with a post-processing device, such as the external processor 112 and/or the external device 110 of FIG. 1) may be operable to utilize the offsets to generate a layout of the data transform command for the decode direction data transform operations (e.g., the source descriptors and/or associated source buffers, the destination descriptors and/or associated destination buffers, and/or data and/or metadata to be included therein) that may be used by the data transform accelerator 210 in the second pipeline 216. Alternatively, or additionally, the software (e.g., the post-processing device) may direct the remaining command structure elements to be populated according to the determined layout.

Alternatively, or additionally, the software (e.g., the post-processing device) may direct output buffers and associated output buffer addresses to be stored in one or more destination descriptors that may be used by the second pipeline 216.

Once the software has populated the layout (e.g., the source descriptors and/or the destination descriptors), the software may transmit the data transform command for the decode direction data transform operations to the data transform accelerator 210. The data transform accelerator 210 may use the source descriptors to read the second metadata 217 (e.g., one or more of the session control words, the source tokens, the action tokens, and the additional metadata, as delineated by the offsets) and/or configure the second pipeline 216. Stated another way, the data transform accelerator 210 may utilize the offsets to delineate the command structure elements, such that one or more of the second data transform engines 218 may consume the second metadata 217 to perform the decode direction data transform operations to generate the decoded output data 230. The second pipeline 216 may obtain the encoded output data 215 (e.g., from the first pipeline 212) and may perform the decode direction data transform operations and direct the decoded output data 230 to the one or more output buffers dereferenced by the destination descriptors.

As described, the above operations may be performed using multiple source

descriptors (and/or associated source buffers) and/or multiple destination descriptors (and/or associated destination buffers). In some embodiments, the second metadata 217 and/or the encoded output data 215 may be stored in a single source buffer (e.g., pointed to by a single source descriptor) and the decoded output data 230 from the second pipeline 216 may be output to a single destination buffer (e.g., pointed to by a single destination descriptor). Alternatively, or additionally, the operations described herein may be utilized in a streaming system (e.g., no source descriptors, source buffers, destination descriptors, destination buffers, etc.). In such instances, input data 220 and/or the encoded output data 215 may be streamed directly into the data transform accelerator 210 (e.g., to the first pipeline 212 and/or the second pipeline 216) with the metadata 222 and/or the second metadata 217 structured as defined herein, and the encoded output data 215 and/or decoded output data 230 (e.g., based on the pipeline to which the corresponding data is input) can stream out allowing a storage device to manage data being submitted and retrieved from the data transform accelerator 210.

In some embodiments, one or more of the first data transform engines 214 may be operable to perform an encryption operation, such as to the encoded output data 215 and/or the second metadata 217. In some embodiments, a key to decrypt the encrypted encoded output data 215 may be included in the second metadata 217. For example, a key may be included as an element of the second metadata 217, which key may be utilized by the second pipeline 216 (e.g., such as one of the second data transform engines 218) to decrypt the encrypted encoded output data 215 to generate the decoded output data 230.

Alternatively, or additionally, the second metadata 217 may be encrypted with the same or similar encryption algorithm as the encoded output data 215, such that a particular key may be used to decrypt the second metadata 217 and the encoded output data 215. Alternatively, or additionally, the encoded output data 215 may be encrypted using a first encryption algorithm and the second metadata 217 may be encrypted using a second encryption algorithm, such a first key may be used to decrypt the second metadata 217 and a second key may be used to decrypt the encoded output data 215. In such instances, the second key (e.g., the key used to decrypt the encoded output data 215) may be included in the second metadata 217, which may increase the security relative to the encoded output data 215. For example, the second metadata 217 may be decrypted using a first key where a second key may be obtained from the decrypted second metadata 217, and the second key may be used to decrypt the encoded output data 215, where the first key and the second key differ from one another (and/or may be associated with differing encryption algorithms).

Modifications, additions, or omissions may be made to the environment 200 without departing from the scope of the present disclosure. For example, as illustrated, the encoded output data 215 and/or the second metadata 217 may be stored in the storage device 240 and may be used to configure the second pipeline 216 in the data transform accelerator 210. However, it will be appreciated that the encoded output data 215 and/or the second metadata 217 stored in the storage device 240 may be used by a second data transform accelerator (not illustrated in FIG. 2) to configure a second pipeline in the second data transform accelerator.

For example, the first data transform engines 214 in the first pipeline 212 in the data transform accelerator 210 may perform encode direction data transform operations, as described herein, and the encoded output data 215 and the second metadata 217 from the encode direction data transform operations may be stored in the storage device 240. At some time after the encode direction data transform operations and storage of the encoded output data 215 and the second metadata 217 in the storage device 240, the second data transform accelerator may obtain the encoded output data 215 and the second metadata 217 from the storage device 240 and may configured a second pipeline operable to perform decode direction data transform operations. The amount of time that may elapse from when the encoded output data 215 and the second metadata 217 is stored in the storage device 240 and when the second data transform accelerator may obtain the encoded output data 215 and the second metadata 217 to configure the second pipeline may be any amount of time, including approximately simultaneous operations.

In another example, the designations of different elements in the manner described is meant to help explain concepts described herein and is not limiting. Further, the environment 200 may include any number of other elements or may be implemented within other systems or contexts than those described. For example, any of the components of FIG. 2 may be divided into additional or combined into fewer components.

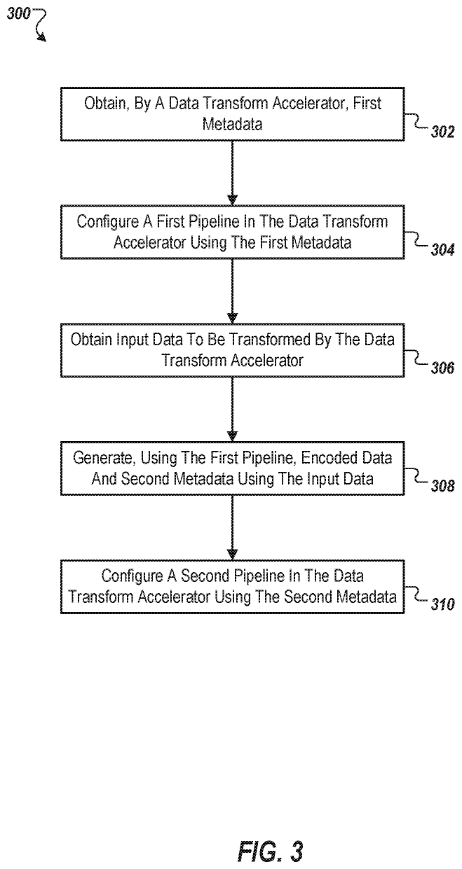

FIG. 3 illustrates a flowchart of an example method 300 of an external device in communications with a data transform accelerator to perform secure processing of data, in accordance with at least one embodiment of the present disclosure. The method 300 may be performed by processing logic that may include hardware (circuitry, dedicated logic, etc.), software (such as is run on a general purpose computer system or a dedicated machine), or a combination of both, which processing logic may be included in any computer system or device such as the external device 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 302, first metadata may be obtained by a data transform accelerator. In some embodiments, the first metadata may be obtained by accessing a data transform command by the data transform accelerator. The data transform command may include at least the first metadata.

In some embodiments, the first metadata may be obtained from a control device. The first metadata may be operable to direct the configuration of a first pipeline in the data transform accelerator. Alternatively, or additionally, the first metadata may be operable to direction the configuration of the second metadata to be generated by the first pipeline.

At block 304, the first pipeline in the data transform accelerator may be configured using the first metadata. The first pipeline may include one or more data transform engines that may be arranged to perform one or more data transform operations to input data.

At block 306, the input data to be transformed by the data transform accelerator may be obtained.

At block 308, encoded data and second metadata may be generated using the first pipeline. The encoded data and the second metadata may be generated using the input data and/or the first metadata. In some embodiments, a first portion of the second metadata may include information associated with a delineation of one or more command structure elements included in a second portion of the second metadata. Alternatively, or additionally, the second portion of the second metadata may include at least one of a session control word, a source token, an action token, and/or additional metadata.

In some embodiments, a data transform engine included in the second pipeline may consume the second portion of the second metadata and may not consume the first portion of the second metadata to generate decoded data. Alternatively, or additionally, a post-processing device may configure a layout of a second data transform command for the second pipeline using the first portion of the second metadata. The post-processing device may populate the layout using the second portion of the second metadata. The post-processing device may include a host computing device.

At block 310, a second pipeline may be configured in the data transform accelerator using the second metadata.

Modifications, additions, or omissions may be made to the method 300 without departing from the scope of the present disclosure. For example, in some embodiments, the second pipeline may generate decoded data using the encoded data. In another example, NVMe PI associated with the encoded data and the second metadata may be generated. In some embodiments, a portion of the encoded data and the second metadata may be combined into one or more sectors associated with the NVMe PI. In some instances, the NVMe PI may be included in the one or more sectors.

In another example, an encryption data transform engine in the first pipeline may encrypt the encoded data using a first key. The encryption data transform engine may encrypt the second metadata using a second key, and in some instances, the second key may be the same as the first key. Alternatively, or additionally, a decryption data transform engine in the second pipeline may decrypt the second metadata using the second key. In some embodiments, the first key may be obtained from the decryption of the second metadata using the second key. The decryption data transform engine may decrypt the encoded data using the first key.

In another example, the designations of different elements in the manner described is meant to help explain concepts described herein and is not limiting. Further, the method 300 may include any number of other elements or may be implemented within other systems or contexts than those described.

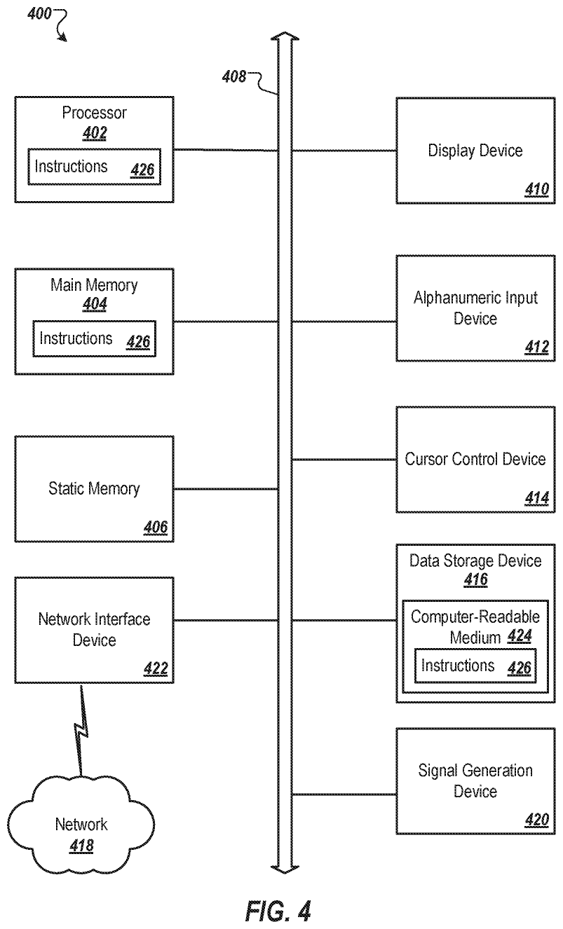

FIG. 4 illustrates an example computing device 400 within which a set of instructions, for causing the machine to perform any one or more of the methods discussed herein, may be executed. The computing device 400 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 400 includes a processing device 402 (e.g., a processor), a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

The processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one implementation, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 424 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure.

The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and

C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or

“B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining, by a data transform accelerator, first metadata;
configuring a first pipeline in the data transform accelerator using the first metadata;
obtaining input data to be transformed by the data transform accelerator;
generating, using the first pipeline, encoded data and second metadata using the input data and the first metadata; and
configuring a second pipeline in the data transform accelerator using the second metadata.

2. The method of claim 1, further comprising generating, by the second pipeline, decoded data using the encoded data.

3. The method of claim 1, wherein the first metadata is obtained by accessing, by the data transform accelerator, a data transform command, the data transform command including at least the first metadata.

4. The method of claim 1, wherein the first metadata is obtained from a control device and is operable to:
direct the configuration of the first pipeline in the data transform accelerator; and
direct the configuration of the second metadata to be generated by the first pipeline.

5. The method of claim 1, wherein:
a first portion of the second metadata comprises information associated with a delineation of one or more command structure elements included in a second portion of the second metadata; and
the second portion of the second metadata comprises at least one of a session control word, a source token, an action token, and additional metadata.

6. The method of claim 5, wherein a data transform engine included in the second pipeline consumes the second portion of the second metadata and does not consume the first portion of the second metadata to generate decoded data.

7. The method of claim 5, further comprising:
configuring, by a post-processing device, a layout of a second data transform command for the second pipeline using the first portion of the second metadata; and
populating, by the post-processing device, the layout using the second portion of the second metadata.

8. The method of claim 7, wherein the post-processing device is a host computing device.

9. The method of claim 1, further comprising generating non-volatile memory express (NVMe) protection information (PI) associated with the encoded data and with the second metadata.

10. The method of claim 9, wherein a portion of the encoded data and the second metadata is combined into one or more sectors associated with the NVMe PI.

11. The method of claim 10, wherein the NVMe PI is included in the one or more sectors.

12. The method of claim 1, further comprising:
encrypting, by an encryption data transform engine in the first pipeline, the encoded data using a first key; and
encrypting, by the encryption data transform engine in the first pipeline, the second metadata using a second key.

13. The method of claim 12, wherein the first key is the same as the second key.

14. The method of claim 12, further comprising:
decrypting, by a decryption data transform engine in the second pipeline, the second metadata using the second key;
obtaining the first key from the decryption of the second metadata; and
decrypting, by the decryption data transform engine in the second pipeline, the encoded data using the first key.

15. The method of claim 1, wherein the first pipeline comprises one or more data transform engines arranged to perform one or more data transform operations to the input data.

16. A data transform accelerator comprising:
one or more data transform engines;
a processing device configured to:
obtain input data and first metadata associated with the input data;
configure a first pipeline comprising at least one of the one or more data transform engines using the first metadata;
direct the first pipeline to perform data transform operations using the input data to generate encoded data and second metadata; and
configure a second pipeline comprising the one or more data transform engines using the second metadata.

17. The data transform accelerator of claim 16, wherein the processing device is further configured to generate, by the second pipeline, decoded data using the encoded data.

18. The data transform accelerator of claim 16, wherein:
a first portion of the second metadata includes information associated with a delineation of one or more command structure elements included in a second portion of the second metadata; and
the second portion of the second metadata comprises at least one of a session control word, a source token, an action token, and additional metadata.

19. The data transform accelerator of claim 16, wherein the processing device is further configured to direct a particular data transform engine of the one or more data transform engines to generate non-volatile memory express (NVMe) protection information (PI) associated with the encoded data and with the second metadata.

20. The data transform accelerator of claim 16, wherein the processing device is further configured to:
direct an encryption data transform engine in the first pipeline to encrypt the encoded data using a first key;
direct the encryption data transform engine to encrypt the second metadata using a second key;
direct a decryption data transform engine in the second pipeline to decrypt the second metadata using the second key;
obtain the first key from the decryption of the second metadata; and
direct the decryption data transform engine to decrypt the encoded data using the first key.
